(19) United States
(12) Patent Application Publication
(10) Pub. No.: US 2009/0304862 A1
(43) Pub. Date: Dec. 10, 2009

(54) BATTER AND BATTER-COATED FOOD PRODUCTS

(76) Inventors: Willem Johannes Lichtendonk, Driebergen-Rijsenburg (NL); Teunis van Vliet, Wageningen (NL); Jendo Eelke Visser, Deventer (NL); Robert Jan Hamer, Amersfoort (NL)

Correspondence Address: BROWDY AND NEIMARK, P.L.L.C.;624 NINTH STREET, NW, SUITE 300, WASHINGTON, DC, 20001-5303, US

(21) Appl. No.: 12/158,984

(22) PCT Filed: Dec. 22, 2006
(86) PCT No.: PCT/NL2006/050327

§ 371 Date: Oct. 28, 2008

(30) Foreign Application Priority Data
Dec. 23, 2005 (EP) 05112974.0

(51) Int. Cl. A21D 2/00; A21D 8/02; A21D 10/04; A23L 1/01; A23L 1/00; A21D 2/36; A21D 8/04

(52) U.S. Cl. 426/20; 426/302; 426/94; 426/305; 426/549; 426/63

(57) ABSTRACT

A batter is provided comprising flour, water and optionally starch, wherein the batter comprises glutenin particles having a volume surface averaged particle size smaller than 10 μm. A batter according to the invention comprises flour and optionally starch, and optionally baking powder and salt. At least 95 vol. % of all particles comprised in the batter have a particle size of 100 μm or less. It appears that such a batter provides very crispy coatings to (deep-)fried products.

### FIELD OF THE INVENTION

The present invention relates to a batter, a food product having a coating comprising the batter and a method of making a batter.

### BACKGROUND OF THE INVENTION

There is a continuing need for coated food products such as coated meat, poultry, vegetables, fruits and fish for frying, baking, grilling, etc. Usually, these coated food products are obtained by coating a raw or at least partly cooked, baked or fried product, optionally frozen, with a batter. This method is also known as “tempura”. Subsequently, a particulate breading material may be applied to the coated product. If desired, the steps of coating and breading can be repeated to obtain a multilayered coating. Before storage, the coating may be pre-set, for instance by a pre-frying treatment.

Batter coated products are often stored at frozen conditions. For consumption, the products are heated, for instance by deep or shallow fat frying, oven baking, roasting, micro wave heating or grilling. An important prerequisite of the batter is that the final product after heating comprises a crispy coating. This is e.g. addressed by U.S. Pat. No. 6,288,179, which provides a battered food product with a crisp texture, a golden brown appearance and a fresh fried taste which retain these desired characteristics even if stored for a period of time after they are fully prepared but before they are consumed. To that end, U.S. Pat. No. 6,288,179 provides a coating of cereal-based batter containing a particular non-gelling milk protein and sodium caseinate.

A dough with small glutenin particles, obtainable by overmixing, has been described by C. Don et al, Journal of Cereal Science 41 (2005) 69-83. Lee et al., Journal of Food Process Engineering 25 (2002) 381-394 relates the batter retention (coating thickness) to the input of mechanic input to the adhesion and tempura batter.

### SUMMARY OF THE INVENTION

It is an object of the invention to provide an alternative batter, which when used as coating on a food product and when cooked, preferably provides a cooked food product, especially a fried or deep-fried food product, with a crispy coating. It is further an object to provide an alternative batter which is stable, preferably more stable than state of the art batters.

Overdeveloping dough is usually not desired, because an overdeveloped dough provides products, such as bread, with a bad texture. It provides leavened products like bread with a poor volume and a bad texture. Surprisingly, it is found that a batter based on an overdeveloped dough, when used as coating on food products, advantageously provides fried or deep-fried food products (“cooked food products”) with a more crispy coating than food products coated with state of the art batters. Further, the batter of the invention appears to be more stable than state of the art batters.

Thus, according to an aspect of the invention, a batter is provided, especially a batter for coating a food product (i.e. a coating batter), the batter comprising flour, water and optionally starch, wherein the batter comprises glutenin particles, and wherein the glutenin particles have a volume surface averaged particle size smaller than 10 μm. In a preferred embodiment, the invention provides a batter (for coating a food product), the batter comprising flour, water and optionally starch, wherein the batter comprises glutenin particles, wherein the glutenin particles have a volume surface averaged particle size smaller than 10 μm, and wherein the batter comprises at least 40 wt. % water. Preferably, at least 95 vol. % of the particles in the batter have a particle size of 100 μm or less.

In yet a further aspect of the invention, there is provided a batter comprising flour, water and optionally starch, having a particle size distribution wherein at least 95 vol. % of the particles (in the batter) have a particle size of 100 μm or less.

According to yet another aspect of the invention, there is provided a method of making a batter comprising mixing flour, water, and optionally starch, and providing a batter comprising glutenin particles having a volume surface averaged particle size smaller than 10 μm.

Further, according to another aspect of the invention, there is provided a method according comprising mixing flour, water, and optionally starch, and providing a batter having a particle size distribution wherein at least 95 vol. % of the particles have a particle size of 100 μm or less. Hence, in another preferred embodiment, the invention provides a batter having a particle size distribution wherein at least 95 vol. % of the particles have a particle size of 100 μm or less, more preferably a batter (for coating a food product), the batter comprising flour, water and optionally starch, wherein the batter comprises glutenin particles, wherein at least 95 vol. % of the particles have a particle size of 100 μm or less, and wherein the batter comprises at least 40 wt. % water.

According to another aspect of the invention a food product having a coating comprising the batter according to the invention is provided. In yet another aspect of the invention there is provided a method of making a food product wherein the method comprises coating a non-fried or non-deep-fried product with the batter according to the invention.

### BRIEF DESCRIPTION OF THE DRAWINGS

FIG. 1 depicts the energy-input versus time when kneading a dough for a batter according an embodiment of the invention;

FIG. 2 shows the particle size distribution of a number of batters according to the invention compared to a standard batter;

FIG. 3 shows the viscosity of batters according to the invention compared to a standard batter;

FIG. 4 shows the number of events when cracking a crust of crusts based on standard batter and a batter according to the invention as function of frying time;

FIG. 5 shows the water content of crusts based on standard batter and a batter according to the invention as function of frying time;

FIG. 6 shows the particle size distribution of another batter according to the invention with overkneading the dough on which the batter is based compared to the same batter, which is not based on an overkneaded (i.e. overmixed) dough.

### DETAILED DESCRIPTION

Herein, the term “tempura” refers to food coated with batter to be used as fried or deep fried product. It relates to the Japanese method of cooking vegetables, shellfish etc.: they are coated with a light (corn) starch batter and deep-fried. The invention especially relates to tempura batters.

The term “gluten” is known to the person skilled in the art and refers to the protein in flour which gives the dough elasticity and strength. Glutenin particles are often also indicated as gluten particles. The term “starch” refers to starches known to the person skilled in the art, in an embodiment also including modified starches. Herein, when starch contents (of the batter) are mentioned, these starch contents refer to added starch, i.e. these contents do not refer to starch contained in the flour.

The term “food product” herein especially refers to a food product such as products selected of one or more of meat, poultry, fish, vegetable, fruit, cereal and nut origin. Examples are for instance French fries, shrimps, cucumber (slices), chicken nuggets, (stuffed) mushrooms, cheese sticks, fish sticks, etc. In a specific embodiment, it refers to the non-cooked, i.e. preferably non-fried or non-deep-fried food product comprising a coating with the batter according to the invention. The term “cooked food product” refers to a cooked food product obtainable by coating a non-fried or non-deep-fried food product with the batter according to the invention and subsequently cooking, preferably frying or deep-frying, the coated non-fried or non-deep-fried food product, respectively. In a variant, the terms “cooking” or “cooked” may also refer to the process of heating in a micro wave or magnetron, (oven) baking, roasting, or grilling. The terms “frying” and “fried” are well known to the person skilled in the art. Frying especially refers to cooking in fat (liquid when heated) or oil in for instance a pan or griddle. In the case of deep-frying, the food is completely immersed in hot oil, whereas when shallow-frying (or “frying) food is cooked in for instance a frying pan where the oil (or liquid fat) generally does not cover the food. The invention is described with reference to frying or deep-frying, but the invention is not limited to those types of cooking. The invention is also directed to the use of the batter in general, also as coating for food products that are cooked otherwise, for instance by heating in a micro wave or magnetron, (oven) baking, roasting, or grilling, etc.

The term “volume surface averaged particle size” also called “Sauter mean diameter” refers to the diameter of a particle whose volume/surface ratio is the same as the arithmetic mean of volume/surface values of the total number of particles belonging to the same sample under examination. The term “volume surface averaged particle size” is known to the person skilled in the art, see also for instance Walstra, Physical Chemistry of Foods, Marcel Dekker Inc., NY, 2002, ch. 9.

As known to the person skilled in the art, “dough” is a mixture of flour and water, and usually a leavening agent (such as baking powder or yeast), which is stiff but pliable. The term “batter” is known to the person skilled in the art and refers to a mixture of flour and water, optionally also comprising starch and other ingredients like baking powder, etc. The primary difference between “dough” and “batter” is the consistency. Dough is thicker and can be moulded by hand, while batter is semi-liquid or liquid (or suspension), and can thus be spooned or poured. Dough and batter may further comprise starch (next to starch contained in the flour). However, instead of water or in addition to water, also milk may be used for the dough or batter. In the invention, the embodiments are described with reference to water. Nevertheless, milk may also be used. Therefore, in an embodiment, contents with respect to water refer to the contents of a liquid comprising one or more of water, ethanol and milk. Hence, for instance the term “at least 35 wt. % water” may in embodiments also refer to “at least 35 wt. % milk” or to “at least 35 wt. % of a mixture comprising milk and water”. Hence, according to an embodiment, the batter further comprises milk. A batter preferably comprises at least 35 wt. % water, preferably at least about 38 wt. % water, more preferably at least 40 wt. % water, even more preferably at least about 45 wt. % water, yet even more preferably at least about 47 wt. % water, even more preferably at least about 50 wt. % water. In general, the batter comprises at least about 35 wt. % liquid, more preferably at least about 40 wt. % liquid, even more preferably at least about 45 wt. % liquid, yet even more at least about 47 wt. % liquid, even more preferably at least about 50 wt. % liquid. The liquid may comprise one or more liquids selected from the group consisting of water, ethanol or milk. Preferably, the liquid comprises water or water and ethanol. When an ethanol comprising liquid is applied, especially an ethanol/water mixture, the ethanol content is preferably in the range of about 5-75 vol. % of the liquid, more preferably in the range of about 20-60 vol. % of the liquid, even more preferably in the range of about 25-50 vol. % of the liquid. Hence, the batter of the invention may further comprise ethanol. Hence, in a specific embodiment, the batter comprises at least 40 wt. % liquid (such as 40-60 wt. %), relative to the batter, wherein the liquid is an ethanol water/mixture, and wherein the ethanol content in the ethanol/water mixture is 5-75 vol. % of the liquid. Hence, the term “water” herein especially refers to water, but in a general embodiment refers to “liquid”, wherein the liquid comprises one or more liquids selected from the group consisting of water, milk and ethanol. Preferably water or a ethanol/water mixture is applied as liquid.

The batter of the invention, when used as coating on food products or comprised in a coating, advantageously provides fried or deep-fried food products (“cooked food products”) with a more crispy coating than food products coated with state of the art batters. The batter of the invention further advantageously is more stable than state of the art batters. Whereas state of the art batters are only stable for a few hours and quickly loose their homogeneity, the batter according to the invention is stable and may stay homogenous for at least 12 hours or even longer (at room temperature).

The batter according to the invention can be made in different ways. In an aspect, the invention provides a method of making a batter comprising mixing flour, water, and optionally starch (i.e. starch in addition to starch comprised in the flour), and providing a batter comprising glutenin particles having a volume surface averaged particle size smaller than 10 μm. The invention is also directed to the batter per se: a batter comprising flour, water and optionally starch, wherein the batter comprises glutenin particles having a volume surface averaged particle size smaller than 10 μm, preferably smaller than 5 μm, even more preferably smaller than 2 μm.

Without being bound to any theory, it appears that the batter according to the invention renders it advantageous properties like stability from the small glutenin particles that do not or do substantially not re-aggregate within a few hours after preparing the batter (vide infra). Even after about 12 hours, the glutenin particles (for instance having a volume surface averaged particle size smaller than 10μ) in the batter according to the invention appear not to re-aggregate to larger particles or show sedimentation. Hence, a batter is provided obtainable by the methods for making a batter according to the invention, wherein the glutenin particles do not re-agglomerate and/or show sedimentation within 12 hours after preparation of the batter when stored at 15-25° C.

According to an aspect of the invention, a batter comprising flour and optionally starch, is provided, further optionally comprising one or more ingredients selected from the group comprising baking powder and salt, wherein at least 85 vol. %, more preferably at least 90 vol. %, even more preferably at least 95 vol. %, yet even more preferably at least 98 vol. % of the particles in the batter have a particle size of 100 μm or less. For instance, at 95 vol. % or more of the particles in the batter may have a particle size in the range of 1-100 μm. State of the art batters, wherein the glutenin particle sizes are not reduced to such an extent as according to the method of making the batter according to the invention, usually have a substantial amount of particles having particle sizes larger than about 100 μm. In the batter according to the invention preferably at least 2 vol. %, more preferably at least 5 vol. %, even more preferably at least 10 vol. %, of the particles in the batter have a particle size of in the range of 10 μm or less. Preferably, the glutenin particles in the batter have a volume surface averaged particle size of less than 10 μm, preferably less than 5 μm, more preferably less than 2 μm. Preferably, the batter according to the invention comprises at least flour and starch.

In a preferred embodiment, the invention provides a method of making a batter which method includes providing flour and water, optionally kneading the flour and water, and providing the optionally kneaded flour and water to a homogeniser, homogenizing, and providing the batter as described herein. The step of homogenizing may be repeated until the desired glutenin particle size is obtained. The starting mixture of flour and water before homogenizing preferably comprises about 20-80 wt. %, preferably 30-65 wt. %, more preferably about 35-50 wt. % flour and about 20-80 wt. %, preferably 35-70 wt. %, more preferably about 50-65 wt. % water. As known to the person skilled in the art, homogenization technology is based on pumping a liquid under high pressure through a narrow slit (opening or valve) to subdivide particles or droplets present in fluids into the very smallest sizes (submicron) and create a stable dispersion ideal for further processing. As known to the person skilled in the art, homogenization features a high concentration of energy released on processed liquids by a combination of fluid mechanical effects like local cavitation, turbulence, shear and impact to achieve a homogeneous particle size distribution. The process may be carried out in a special designed valve, which represents the core of the homogenizing process. The passage of fluid through the minute flow passages in the valve under high pressure and controlled flow action subjects the fluid to conditions of high turbulence and shear that creates a highly efficient mechanism for particle and droplet size reduction.

After making the homogeniser product, starch and other components like salt, baking powder, emulsifiers, etc., may be added (vide infra). Salt and baking powder may also be added to the mixture of flour and water to be homogenized, i.e. before homogenizing the mixture of water and flour. Starch is preferably added after homogenizing the product in the homogenizer and is thus preferably admixed with the homogenizer product, with techniques known to the person skilled in the art. During the process, for instance to the mixture of flour and water to be homogenized, or to the homogenizer product, optionally other additives may be added, such as for controlling the particle size of the glutenin particles (vide infra).

In yet another preferred embodiment, the invention provides a method of making a batter mixing flour and water, kneading the flour and water until an over-developed dough is obtained, admixing water and providing the batter according to the invention. In this method, first an overkneaded (overdeveloped or overmixed) dough is made. This overdeveloped dough comprises glutenin particles having a volume surface averaged particle size of less than 10 μm, preferably less than 5 μm, more preferably less than 2 μm. In general, overkneading a dough in for example bread making is not desired, since this leads to an undesirable compact flat bread. However, it appears that the above-mentioned advantageous properties of the batter according to the invention are also obtained when the batter is based on an overdeveloped dough. Such dough can be obtained when the kneading/mixing power (energy.s⁻¹) input is continued after reaching a maximum, until a kneading/mixing power input is obtained of equal or less then about 80% of the maximum energy input. According to a specific embodiment, a method is provided wherein the over-developed dough is obtained by kneading the flour and water such that after reaching a maximum torque value, kneading is continued until a final torque value is obtained of equal to or less then 80% of the maximum torque value. More preferably, the final torque value is less than about 70% of the maximum torque value; yet even more preferably, the final torque value is less than about 65% of the maximum torque value. The term “torque” is known in the art, see for instance Lyklema, Fundamentals of Interface and Colloid Science, Vol. IV, Particulate Colloids, Elsevier, Amsterdam, 2005, Ch. 6.

In this way, a mixture of flour and water is obtained wherein the glutenin particles have the desired particle size, and do not or do not substantially re-agglomerate to larger particles for hours, for instance for at least 12 hours. The starting mixture of flour and water before kneading preferably comprises about 50-80 wt. % flour, more preferably 60-70 wt. % and about 20-50 wt. % water, more preferably 30-40 wt. % water. The person skilled in the art knows how to make dough. The mixture may further comprise baking powder and salt (vide infra). Preferably, salt is added to the mixture of flour and water, because this advantageously enables the production of a less sticky dough. Further, optionally other additives may be added for controlling the particle size of the glutenin particles (see below).

The overdeveloped dough is also an aspect of the invention. Such dough may be further processed to obtain the batter according to the invention (see below), but may also be stored, preferably after an optional freeze-drying step. This enables the option of a later processing or processing to a batter at another place.

After making the overdeveloped dough, starch and other components like salt, baking powder, emulsifiers, etc., may be added, as will be known to the person skilled in the art. Subsequently, the overdeveloped dough may be mixed with these additional components and water may be added to facilitate mixing. However, components like salt and baking powder may also have been added to the primary mixture of flour and water. To obtain the batter according to the invention, the dough after overkneading, i.e. the overdeveloped dough, will in general further be diluted with water. In a preferred embodiment, water is admixed such that a batter is obtained comprising 35-70 wt. % water, relative to the total weight of the batter. More preferably, the water content is about 38-70 wt. %, more preferably about 40-60 wt. %, even more preferably about 45-60 wt. %, yet even more preferably about 47-60 wt. %, more preferably about 50-60 wt. % relative to the total weight of the batter.

In the above described embodiments of the method of the invention, one or more additives may be added for controlling the particle size of the glutenin particles. In an embodiment, one or more additives are used which are selected from the group consisting of proteolytic enzymes, SH-groups containing proteins (i.e. proteins containing free SH groups), peptides and amino acids, and other compounds that specifically facilitate reduction of the glutenin particles size. Preferred examples of such particle size controlling additives are selected from the group consisting of soy protein, cysteine, glutathione, wheat bug protease (for instance Eurygaster integriceps protease) and sodium metabisulphite. In an embodiment, the phrase “controlling the particle size of the glutenin particles” refers to preventing or reducing re-aggregation of broken up glutenin particles. Hence, in an embodiment, the additive is used to facilitate reduction of the particle size of the glutenin particles. The additives may be used as blockers of SH-groups, thereby controlling re-agglomeration (re-aggregation). Therefore, according to an aspect of the invention, a method of making a batter is provided, wherein optionally SH-group blockers are used. SH-group blockers may prevent re-agglomeration of the glutenin particles in the dough or batter according to the invention. SH-group blockers may for instance comprise sodium metabisulphite and SH-groups containing proteins, peptides and amino acids such as soy protein, cysteine, and glutathione.

According to another aspect of the invention a method of making a dough or batter according to the invention is provided, wherein a proteolytic enzyme is used to reduce the particle size of the glutenin particles to the desired particle size specifications (see above). For instance, the starting components for the batter or dough, preferably a batter, may be mixed and the proteolytic enzyme, like wheat bug protease, may be added to reduce the glutenin particle size. In an embodiment, the glutenin particles in a mixture comprising flour and water are reduced in particle size by the proteolitic enzyme. Subsequently, the other ingredients are admixed such as the optional starch, baking powder, salt and other optional ingredients. Hence a method is provided comprising providing flour, water, and optionally starch (and optionally other components), wherein the glutenin particles are reduced in particle size by the proteolytic enzyme, preferably wheat bug protease (Eurygaster integriceps protease), to the volume surface averaged particle size of smaller than 10 μm (or other described preferred values) and/or to a particle size distribution wherein at least 95 vol. % of the glutenin particles have a particle size of 100 μm or less, and providing the dough or batter according to the invention. Especially preferred enzymes are those proteases produced by heteropterous insects, such as the suni-bug, of the genera Eurygaster spp, Aelia spp. and Nysius huttoni. Examples thereof are for instance Eurygaster maura and Eurigaster integriceps. However, also other sources of protease can be used. The normally undesired presence of these bugs and proteases produced thereby, surprisingly leads to a coating batter which provides a crust which is crispier after frying and which has a good crispiness retention.

The enzyme material (i.e. enzyme or enzyme comprising material) employed in the present method advantageously contains one or more industrial enzymes that are approved for use in food and that exhibit considerable proteolytic activity, especially endopeptidase activity. The proteolytic enzymes in the present enzyme material may suitably be derived from plant, microbial or animal sources. Particularly preferred are enzymes derived from plant, fungal (in particular Aspergillus, more particularly Aspergillus oryzae) or bacterial sources (in particular Bacillus), botanical and fungal sources being most preferred. Preferably other enzyme activities are essentially absent. Examples of enzymes that are particularly suitable for use in the present method include papain, bromelain, ficin, trypsin, chymotrypsin, Corolase™, debitrase™ and especially wheat bug protease (or bug wheat protease).

When using a proteolytic enzyme, such as wheat bug protease, the amount of enzyme used is preferably selected to provide a batter wherein the glutenin particles are reduced in particle size to the herein describe particle size range and/or particle size distribution. Preferably, the enzyme amount is selected to maintain the volume surface averaged particle size of the glutenin particles in the batter below 10 μm and above about 2 μm for about 12 hours. Further, the enzyme amount is preferably selected to reduce the glutenin amount by at least about 30%, more preferably at least 40%, even more preferably at least 50% (i.e. relative to the amount before adding the enzyme).

The enzyme preferably exhibits a proteolytic activity of at least 10³ CDU per gram of dry matter. The term “proteolytic activity” refers to the capability of an enzyme to split proteins or peptides into smaller peptides or amino acids. As known in the art, the proteolytic activity of the enzyme material can suitably be expressed in terms of casein digestion units (CDU), which is determined by measuring the hydrolysis of casein under standardised conditions. Typically, the enzyme material employed in accordance with the present invention exhibits a proteolytic activity of at least 10³ CDU per gram of dry matter. Preferably, the enzyme exhibits a proteolytic activity of at least 10⁴ CDU, even more preferably of at least 10⁶ CDU per gram of dry matter. In addition, the proteolytic activity of the enzyme material preferably does not exceed 10⁹ CDU per gram of dry matter.

In another preferred embodiment of the invention, the enzyme material is applied in an amount of at least 10 CDU, more preferably at least 50 CDU proteolytic activity per gram of the flour (i.e. relative to the weight of the flour in the batter to be applied to the food product). Typically, the amount of proteolytic activity applied will not exceed 2.5*10⁴ CDU per gram flour (in the batter). Hence, in a specific embodiment, the batter comprises enzymes (enzyme material) in an amount of about 10-25000 CDU proteolytic activity per gram of the flour in the batter.

As will be clear to the person skilled in the art, a combination of particle size reduction methods is also possible. For instance, the one or more additives for controlling the particle size, especially one or more proteolytic enzymes may be added to the dough to be overkneaded, or may be added to the batter based on an overkneaded dough, or may be added to the dough and the batter. Likewise, the one or more additives for controlling the particle size, especially one or more proteolytic enzymes may be added to the product to be homogenized or may be added to the homogenized product or may be added both before and after homogenizing the product. As will be clear to the person skilled in the art, the one or more additives for controlling the particle size, especially one or more proteolytic enzymes, may also be added during kneading, during homogenizing or during diluting intermediate products, such as the overkneaded dough, to the desired batter. Hence, in an embodiment, a batter is provided further comprising proteolytic enzymes, preferably one or more selected from the group consisting of wheat bug proteases, preferably one or more selected from the group consisting of Eurygaster protease, Aelia protease or Nysius huttoni protease. After providing the batter with one or more proteolytic enzymes, preferably at least about 0.1-0.3 h is waited before applying the batter as coating, more preferably at least about 0.5 h is waited. In this way, the enzyme can reduce the particle size of the glutenin. In general, the batter will be applied as coating within about 20 h, more preferably within about 12 h after preparation.

In a specific embodiment, there is provided a batter comprising 15-65 wt. % flour, 0-45 wt. % starch, 35-70 wt. % water and optionally 0.1-2 wt. % baking powder and 0-2 wt. % salt, relative to the total weight of the batter. The batter may further comprise about 0-2% other minor ingredients, such as emulsifiers, texturisers, etc. As will be clear to the person skilled in the art, the total amounts of the components add up to 100 wt. %. Preferably, the batter comprises 10-30 wt. % starch.

Baking powder is known to the person skilled in the art and is commercially available. Baking powder is used to leaven baked goods. Baking powder usually consists of a mixture comprising baking soda, one or more leavening acids, and a diluent. For a more detailed description, see for instance: Hoseney R. C., Wade, P., and Finley, J. W. in Wheat Chemistry and Technology, vol. 11, chapter 7, pages 430-431 Y. Pomeranz, editor. third edition 1988, published by American Association of Cereal Chemists, Inc, St Paul, Minn., USA. The addition of baking powder is not necessary, but may provide additional advantageous features to the end product in terms of brittleness/crispiness. Likewise, the addition of salt is not necessary, but addition may give the coating a better taste. Further, the addition of salt advantageously facilitates the dough making process according to an embodiment of the invention (vide supra).

Addition of starch is also not necessary, however preferred. Flour comprises starch (usually about 64-71 wt. % relative to the total weight of the flour), but the addition of extra starch to the batter is advantageous since less, relative expensive, flour may be used when starch is being added, like potato starch. Hence, herein the phrase “0-45 wt. % starch”, or other similar terms, refers to additional starch, i.e. starch added in addition to the starch that may be present in flour. Starch present in flour is not taken into account in the phrase “0-45 wt % starch” etc., as further exemplified in the appending examples.

To obtain the desired batter, after homogenizing in a homogenizer or after overkneading, the product obtained after homogenizing or overkneading may be further diluted to provide the batter of the invention. In an embodiment, water is admixed such that a batter is obtained comprising 35-70 wt. % water, relative to the total weight of the batter (see also above).

Preferably, the batter of the invention comprises:

| | | |
|---|---|---|
| flour: | 30-50 | wt. %; |
| starch: | 10-30 | wt. %; |
| baking powder: | 1-2 | wt. %; |
| salt: | 0-2 | wt. %; |
| others: | 0-2 | wt. %; |
| water up to | 100 | wt. %. |

Preferably, the water content of the batter according to the invention is about 38-70 wt. %, more preferably about 40-60 wt. %, even more preferably about 45-60 wt. %, yet even more preferably about 47-60 wt. %, even more preferably about 50-60 wt. % relative to the total weight of the batter. As described above, at least part of the water may in an embodiment be replaced by one or more of milk and ethanol. Hence, the invention further provides a method for making a batter wherein water is admixed such that a batter is obtained comprising 40-60 wt. % water, more preferably 50-60 wt. % water, relative to the total weight of the batter. Instead of water, also a liquid may be applied comprising one or more selected of the group consisting of water, milk and ethanol, preferably selected from the group consisting of water and ethanol.

In yet another embodiment, a method for making a batter is provided, the method comprising mixing flour, water, ethanol and optionally starch, and providing a batter comprising glutenin particles having a volume surface averaged particle size smaller than 10 μm. In again another embodiment, a method for making a batter is provided, the method comprising mixing flour, water, ethanol and optionally starch, and providing a batter having a particle size distribution wherein at least 95 vol. % of the particles have a particle size of 100 μm or less (this particle size distribution refers to all particles in the batter). When an ethanol water mixture is applied, the ethanol content is preferably in the range of about 5-75 vol. % of the liquid, more preferably in the range of about 20-60 vol. % of the liquid, even more preferably in the range of about 25-50 vol. % of the liquid.

In an embodiment, an ethanol/water mixture is applied. Hence, in a specific embodiment, the invention provides a method comprising providing flour and water, optionally kneading the flour and water, and providing the optionally kneaded flour and water to a homogeniser, homogenizing, and providing the batter, the method further comprising admixing ethanol, wherein ethanol is admixed at one or more stages selected from the group consisting of before homogenizing, during homogenizing and after homogenizing. In yet another embodiment, the invention provides a method comprising mixing flour and water, kneading the flour and water until an over-developed dough is obtained, admixing water and providing the batter, the method further comprising admixing ethanol, wherein ethanol is admixed at one or more stages selected from the group consisting of before kneading, during kneading and after kneading. In yet another embodiment, a method is provided comprising providing flour, water, and optionally starch, wherein the glutenin particles are reduced in particle size by a proteolitic enzyme to the desired particle size, the method further comprising admixing ethanol, wherein ethanol is admixed at one or more stages selected from the group consisting of before adding the proteolytic enzyme, while adding the proteolytic enzyme and after adding the proteolytic enzyme.

The batter of the invention preferably has a liquid egg content of less than 5 wt. %, preferably even less than about 2 wt. %, and more preferably zero liquid egg content. The term “liquid egg” refers to the liquid obtainable from fresh eggs (including egg yolk and egg white), as known to the person skilled in the art.

In a preferred embodiment, the flour is selected from the group consisting of (1) wheat flour, (2) oat flour, (3) barley flour, (4) rye flour and (5) the combination of corn and rice flour. Combinations of two or more flours from the group of wheat, oat, barley, rye and the combination corn/rice flour may also be used. For instance, a combination of wheat and oat flour may be used, or a combination of wheat, corn and rice flour may be used. Usually the protein content of flour is about 7-15% wt. %. Preferable, flours are used having a relatively high gluten content, like at least 8-10 wt. % (relative to the flour). Preferably a flour is used wherein the flour comprises 2-4 wt. % protein other than gluten, relative to the weight of the flour. Such proteins are for instance albumins and enzymes, which may for instance be selected to be used to control the viscosity of the batter. Preferably, the batter comprises also starch (i.e. additional starch) (and optional other ingredients like baking powder, salt, etc.). The batter according to the invention preferably comprises a starch selected from the group consisting of corn, potato, tapioca and cereal starch (e.g. wheat or rice starch). Combinations of two or more starches may also be used. Preferably, a batter is provided wherein the flour comprises wheat flour and wherein the starch comprises wheat starch.

As mentioned above, the invention is directed to a batter with glutenin particles having a volume surface averaged particle size smaller than 10 μm.

The invention is also directed to a batter wherein at least 85 vol. %, more preferably at least 90 vol. %, of the particles comprised in the batter have a particle size of 100 μm or less. In a specific embodiment, a batter is provided wherein at least 95 vol. % of the particles have a particle size of 100 μm or less.

The volume surface averaged diameter of the gluten in such batter is preferably between about 0.01 and 10 μm, more preferably between about 0.1 and 5 μm, even more preferably between about 2 and 5 μm.

Preferably, a batter according to the invention comprises the feature of having an apparent viscosity of less than 0.6 Pa·s at shear rates between 10 and 1000 s⁻¹, more preferably less than about 0.5 Pa·s. Preferably, the apparent viscosity of the batter according to the invention is set at values between about 0.05 and 0.6 Pa·s, more preferably between about 0.1 and 0.5 Pa·s at these shear rates. State of the art batters for these applications have apparent viscosities in the range of about 0.65 Pa·s or larger. In the art, instead of the term “apparent viscosity” also the term “viscosity” is used. The apparent viscosity conditions are based on batters comprising 47.5 wt. % water. In case a batter comprises another percentage of water, the batter may be diluted with water or concentrated to a water content of 47.5 wt. %. Then the apparent viscosity is measured and a batter according to the invention may fulfil above mentioned criteria, whereas batters not according to the invention do not. Hence, a batter according to the invention has an apparent viscosity of less than 0.6 Pa·s at shear rates between 10 and 1000 s⁻¹ when the water content of the batter is 47.5 wt. % (+1 wt %, i.e. between 46.5 and 47.5 wt. %) or is brought at this value of 47.5 wt. % (+1 wt %).

The viscosity of the batter at shear rates of about 100 s⁻¹ is preferably in the range of about 1-10,000 mPa s⁻¹, more preferably between about 5 and 2000 mPa s⁻¹ (at 20° C.), even more preferably below about 500 mPa s⁻¹ (at 20° C.) at a shear rate of about 100 s⁻¹, such as in the range between about 10 and 500 mPa s⁻¹ (at 20° C.) at a shear rate of about 100 s⁻¹.

Preferably, the batter according to the invention has an apparent viscosity value at shear rates between 10 and 1000 s⁻¹ which is at least 10%, more preferably at least 20%, even more preferably at least 30%, yet even more preferably at least 40%, and even more preferably at least 50% lower than a standard batter with the same composition and measured under the same conditions and provided via state of the art preparation. Hence, in an embodiment, a batter is provided, obtainable by the method according to the invention, having an apparent viscosity value at shear rates between 10 and 1000 s⁻¹ which is at least 10%, lower than a standard batter with the same composition and measured under the same conditions, wherein the standard batter is obtainable by mixing flour, water, and optionally starch (and optional other components).

According to yet another aspect of the invention there is provided a food product having a coating comprising the batter. Hence, the invention also provides a method of making a food product comprising coating a non-fried or non-deep-fried food product with the batter according to the invention, which batter is obtainable by the method(s) of making a batter according to the invention. As mentioned above, the food product may preferably comprise a filling selected of one or more of meat, poultry, fish, vegetable, fruit, cereal and nut origin. Coating may be performed by methods known to the person skilled in the art. Preferably, a coating method is used wherein coating is performed by submerging the non-fried or non-deep-fried food product in the batter, by spraying the batter on the non-fried or non-deep-fried food product or by coating the non-fried or non-deep-fried food product with the batter, thereby providing the food product having a coating comprising the batter according to the invention. The batter for coating on the food product may used as such. In a further embodiment, a coating liquid comprising the batter is used, wherein the coating liquid may further comprise other ingredients, like texturisers, emulsifiers, flavours, fragrances, aroma's, colorants, etc. After coating with the batter or coating liquid, breadings may be applied to the coated food product. Further, the food product may also comprise multiple coatings with the batter or with a coating liquid comprising the batter, as will be clear to the person skilled in the art. Usual coating thicknesses with the batter according to the invention are between about 0.1 mm and 2 mm.

The method for coating the non-fried or non-deep-fried food product may be performed on a frozen or deep frozen non-fried or non-deep-fried food product (thus the coating of the non-fried or non-deep-fried food product may be performed on a frozen or deep frozen filling). The food product to be coated, i.e. the non-coated non-fried or non-deep fried food product may be frozen or non-frozen when the batter coating of the invention is applied.

In a specific embodiment, a method of making a food product comprising coating a non-fried or non-deep-fried food product as mentioned above is provided, further comprising frying or deep-frying the coated non-fried or non-deep-fried food product, respectively. Hence, according to another aspect of the invention, a cooked food product obtainable by such method is provided, i.e. a food product having a coating (crust) based on the batter of the invention.

In general, the coated food product, i.e. the coated non-fried on non-deep-fried food product is subjected to a pre-frying or pre-deep-frying, as known in the art, and then frozen or deep-frozen. The thus obtained fried (including deep-fried) and frozen (including deep-frozen) product can be distributed to the consumer for final frying (including deep-frying).

Hence, in an embodiment, the invention provides a food product having a coating comprising the batter according to the invention. In yet another embodiment, the invention provides a frozen food product obtainable by coating a non-fried or non-deep-fried food product with the batter according to the invention, optionally pre-frying or pre-deep-frying the coated non-fried or non-deep-fried food product, respectively, and freezing the thus obtained food product. In yet another embodiment, the invention provides a cooked food product obtainable by coating a non-fried or non-deep-fried food product with the batter according to the invention and subsequently frying or deep-frying the coated non-fried or non-deep-fried food product, respectively. As mentioned above, the food product, or the frozen food product, or the fried or deep-fried food product comprises a filling selected of one or more of meat, poultry, fish, vegetable, fruit, cereal and nut origin.

The batter of the invention is a “coating batter”, i.e. a batter that can be used for coating food products, especially the fillings as described herein. Such products can be used in the snack industry. Hence, the “batter for coating” or “coating batter” herein is especially suitable for providing a coating (crust) to snacks. Herein, crust refers to the coating of the coating batter on a food product after frying (including deep-frying) the coated food product. Batters known as “crepe batters” are herein not included in the term batter.

The method of coating and the snacks (or other food products) may be known per se, but the batter of the invention provides the advantages of a more crispy crust and/or a crust with better crispiness retention. A further advantage of the batter of the invention is that the coating based on the batter does surprisingly contain less fat after frying. It appears that the amount of fat (or oil) is reduced in the crust obtained after frying. Less frying fat is included, which may be due to the fact that the amount of water included in the crust is reduced. Hence, the batter of the invention also contributes to more healthier food. Therefore, in an another aspect, the invention provides the use of the batter according to the invention for providing a fried or deep-fried food product with a crust with a reduced fat content. Hence, the invention further provides the use of the batter according to the invention for reducing fat inclusion during frying or deep-frying the batter coated food product (i.e. reducing fat inclusion in the crust obtained after frying or deep-frying the coated food product). The invention also provides the use of an overkneaded dough as described herein to provide such coating. The invention especially provides the use of bug wheat protease in a batter for coating a food product to reduce the inclusion of fat in a crust obtained after frying or deep-frying the coated food product.

Most of the embodiments described above are described with water as liquid. However, instead of water one may in an embodiment also read one or more liquids selected from the group consisting of water, milk and ethanol.

### EXAMPLES

### Example 1

### Batters

### Batter 1: Preparation of Standard Batter (State of the Art)

An example of the method for preparing a standard batter is the following:

Mix a batter of 330 grams of wheat flour, 330 grams of potato starch, 13.2 grams salt, 19.8 grams baking powder and 627 ml water of room temperature in a bowl of a Hobart mixer at stage 1 for 3 minutes. Control that the batter is homogeneous. Let the batter rest for one hour before use. The weight ratio of this batter is the following recipe:

| | |
|---|---|
| Wheat flour: | 25; |
| Potato starch: | 25; |
| Salt: | 1; |
| Baking Powder: | 1.5; |
| Water: | 47.5 |

The properties of the Hobart mixer are: Brand: Hobart; Model: N-50; S.N.: 99-707-970; Max. Rpm: 1425; Stages: 3.

### Batter 2: Preparation of Hatter by Extreme Over Mixing

An example of an effective method for preparing a batter by extreme over mixing is the following:

Mix a dough of 250 grams of wheat flour, 5 grams salt and 150 ml cold water (0°-5° C.) in a 300 grams bowl of a Brabender Plastograph at 100 rpm. As soon as the flour is hydrated, speed up the mixer from 100 to 150 rpm. Cool the bowl by a water bath to 0° C. The curve of the torque soon shows a rather sharp maximum. Continue mixing until the torque has at least become 30% less than the maximum torque (has decreased at least by 30% from its maximum value). Stop mixing and remove half of the weight of the dough. Add 125 grams of potato starch, 2.5 grams salt, 6.5 grams baking powder and 65 ml of cold water (0-5° C.). Start again the mixer with 150 rpm for 10 minutes. Slowly dilute the dough with 100 ml cold water (0-5° C.) at a speed of 150 rpm. The batter is ready to use. The weight ratio of this batter is the following recipe.

| | |
|---|---|
| Wheat flour: | 25; |
| Potato starch: | 25; |
| Salt: | 1 |
| Baking Powder: | 1.5; |
| Water | 47.5 |

Properties of this Brabender Plastograph are: Brand: BRABENDER; Type: Plastograph 810108,007; S.N.: 991271; Year 1999; Max RPM: 150; PT100 temperature measured.

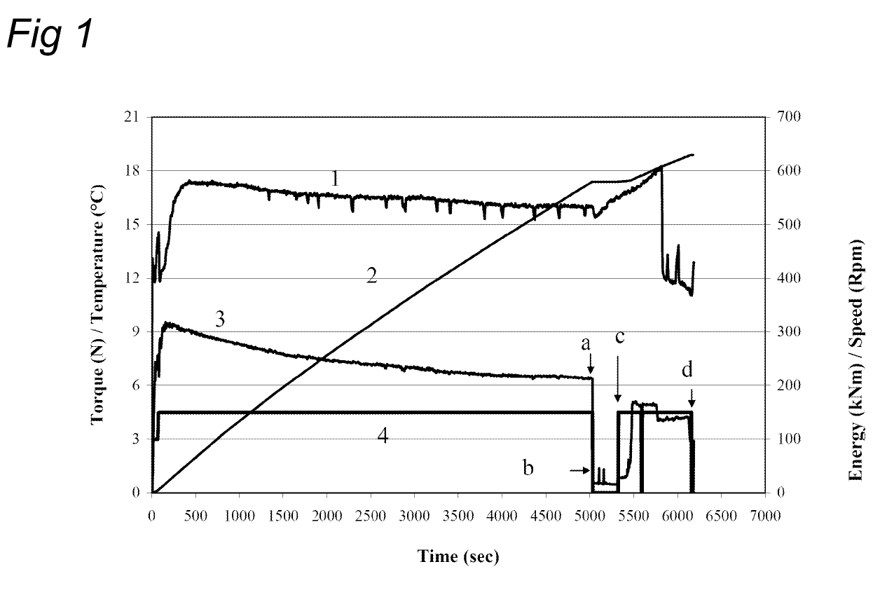

FIG. 1 shows the temperature (reference number 1), the energy (reference number 2), the torque (reference number 3) and the speed (reference number 4) of the mixer during the dough-batter mixing curve, i.e. overkneading (overdeveloping) a dough and formation of a batter. Speed 4 is constant at 150 RPM, except for a period between about 5000 seconds (reference number a), and then half of the dough thus obtained is removed (reference number b). 125 gram potato starch and 65 ml cold water are added and mixing is continued again at c. Then, the mixture is diluted with water (reference number d) to obtain the batter according to the invention. In this way, a batter is provided based on an over-developed dough, wherein the over-developed dough is obtained by kneading the flour and water (and the optional component salt) such that after reaching a maximum torque value, kneading is continued until a final torque value is obtained of equal to or less then 70% of the maximum torque value. Thereafter, the dough is diluted with water and starch is added.

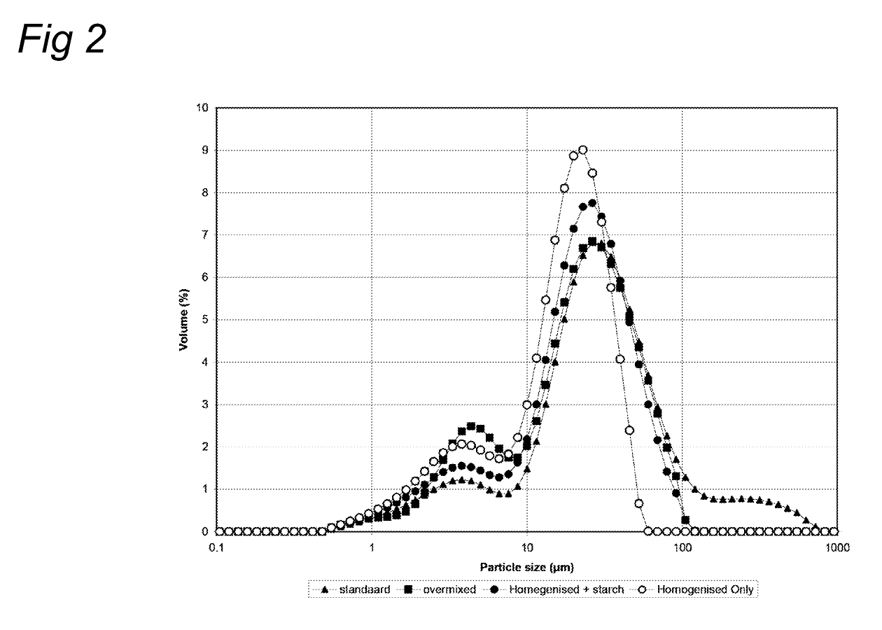

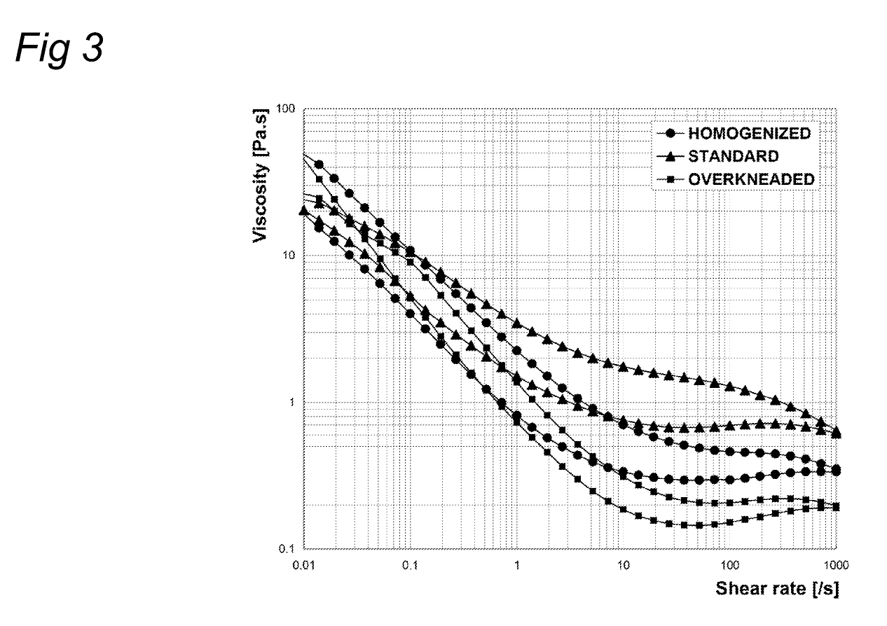

Note that the maximum energy input applied in the above-mentioned article by Lee et al is about 5000-8000 Nm/kg (FIGS. 2 and 3) while herein the energy applied at the end of the overmixing stage is about 575 kNm/0.405 kg (FIG. 1), which is about 1400,000 Nm/kg, which is nearly two orders of magnitude larger. Hence, a preferred minimum input in the invention is about 200,000 Nm/kg, more preferably at least about 500,000 Nm/kg. Here, the amount refers to the amount of product (mixture of at least water and flour) that is overmixed (overkneaded or overdeveloped). In general this will be dough, which is later diluted to a batter, and to which later optionally starch and one or more other optional ingredients may be added, such as selected from the group consisting of baking powder, salt, one or more enzymes (such as one or more bug wheat proteases), colorants, flavours and fragrances, etc.

### Batter 3: Preparation of Batter by Homogenizing

An example of an effective method for preparing a batter by homogenizing with a homogenizer is the following:

Make a mixture of wheat flour, salt, baking powder and cold water (0-5° C.) in a Hobart mixer (3 minutes at stage 1) to get a good suspension. Use the weight ratio of the following batter recipe, but without the starch, because this will be added later. The reason is that the total batter recipe gives a too high viscosity to get it through the pump. The following recipe was used:

| | |
|---|---|
| Wheat flour: | 25; |
| Potato starch: | 25; |
| Salt: | 1 |
| Baking Powder: | 1.5; |
| Water: | 47.5 |

When the suspension looks homogeneous, it is pumped into a homogenizer. The properties of the homogenizer are: Brand: NIRO SOAVI; Type: Panda; S.N.3030; Year: 1996; Max Press 150 Mpa; Rated flow (dm3/h): 10.

The handling of the batter for this example is as follows: fill the homogenizer (which is located in a cold room of 5° C.) with water and bring the pressure to a level of 100 bar for stage 1 and also 100 bar for stage 2. Let the batter pass the homogenizer 10 times. Put the batter again into the bowl of the Hobart mixer. Add the potato starch and mix for 3 minutes at stage 1. The batter is ready to use. The properties of the Hobart mixer are: Brand: Hobart; Model: N-50; S.N.: 99-707-970; Max. Rpm: 1425; Stages: 3.

### Example 2

### Particle Size Measurements

FIG. 2 shows the particle size distribution of the batter thus obtained, as measured with a Malvern. The properties of this Malvern are: Brand: Malvern, Type: Mastersizer Hydro 2000S (Malvern Instruments, Southborough, UK); Year: 2004 (software version 5.22). Particle sizes were determined using this Malvern laser diffraction apparatus. As will be clear to the person skilled in the art, the measurements are based on low angle laser light scattering. Thereto the samples were diluted to an appropriate extent with water (see instruction instrument). The light diffraction pattern obtained were analyzed in terms of particle size distribution using Fraunhofer diffraction theory, assuming a spherical particle shape. Results were checked by analyzing the light diffraction pattern also by using the Mie theory. As known to the person skilled in the art, from the particle size distribution the volume surface averaged diameter d₃₂ can be calculated using:

$${d}_{32} = \frac{{\int }_{0}^{∞} {d}^{3} f ( d ) d d}{{\int }_{0}^{∞} {d}^{2} f ( d ) d d} \approx \frac{{\sum }_{i = 1} {N}_{i} {d}_{i}^{3}}{{\sum }_{i = 1} {N}_{i} {d}_{i}^{2}} \qquad ( 1 )$$

Herein d is diameter, f(d) is the frequency distribution of the number and Nᵢ the number of particles in size class i and dᵢ the value of d characterizing class i (midpoint of class i). The first part of equation 1 is based on the assumption that the size distribution is a continuous one and for the second part it is assumed that the distribution can be split into size classes.

The x-axis indicates the particle size as measured and the y-axis the volume percentage. In FIG. 2, the triangles represent a standard batter (batter 1), the cubes represent a batter based on an over-developed dough (batter 2), homogenised only, indicated with open circles relates to a homogenized batter (batter 3) before starch is added (see FIG. 1 at (a)) and the closed circles refer to a homogenized batter with starch (i.e. batter 3 (see FIG. 1 at (d))). All batters have the same composition, nevertheless, the particle size distributions are substantially different. Important differences are the fact that the particles with size above about 100 μm seem to have disappeared. In contrast thereto, the range between 1 and 10 μm shows an intensity increase. From these data, for example from the difference between the curves of a standard (mere mixing of ingredients) and a batter with the same composition but prepared according to the invention (i.e. the difference between a batter according to the invention and a batter comprising the same ingredients in the same amounts, but only mixed and not overkneaded or homogenized in a homogenizer), it can be concluded that the invention provides a batter comprising flour, water and optionally starch (and optional other ingredients or additives), wherein the batter comprises glutenin particles having a volume surface averaged particle size smaller than 10 μm.

The volume surface averaged diameter of the particles in the batter is about 12 μm for the standard batter (1), for the overkneaded dough batter (2) about 9.9 μm, for the homogenized+starch batter (3) also about 9.9 μm and for the homogenized without starch batter about 8.2 μm.

From these data it can also be concluded that the invention provides a batter wherein at least 95 vol. % of the particles have a particle size of 100 μm or less. This batter may in a preferred embodiment be a batter comprising glutenin particles having a volume surface averaged particle size smaller than 10 μm. It further appears that in the batter according to the invention at least about 5 vol. % of the particles in the batter have a particle size of in the range of 10 μm or less.

In case wheat starch and wheat flour would be used, the invention provides a batter wherein at least 85 vol. %, more preferably at least 90 vol. %, even more preferably at least 95 vol. %, yet even more preferably at least 98 vol. % of the particles in the batter have a particle size of 80 μm or less.

State of the art batters, wherein the glutenin particle sizes are not reduced to such an extent as according to the method of making the batter according to the invention, usually have a substantial amount of particles having particle sizes larger than about 100 μm (for instance due to the presence of glutenin particles).

In case a dough is made without overkneading, the glutenin particles may re-agglomerate, which is the case when dough is kneaded according to the standards for bread preparation. However, according to the invention, when overkneading the dough, the dough, the batter based on such dough, the glutenin particles have been reduced in particle size to such an extent, that it appears that they do not substantially re-agglomerate. The same applies for the batter provided with the homogenization method. Further, re-agglomeration may also be diminished or inhibited by adding additives for controlling the particle size of glutenin particles.

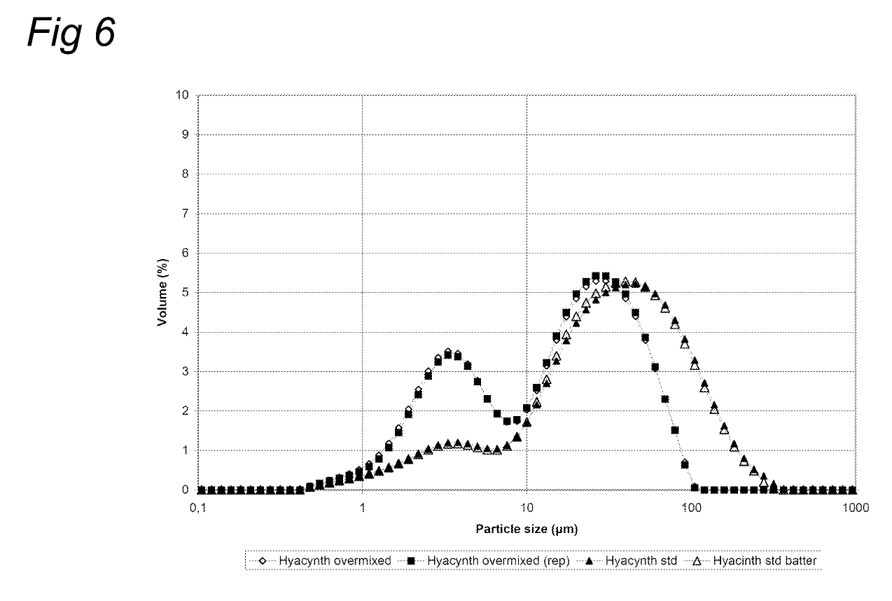

FIG. 6 shows another example of a batter according to the invention. The batters depicted in FIG. 2 were based on “Zeemeeuw flour”, whereas the batter depicted in FIG. 6 is based on “hyacinth flour”. Hyacinth has a protein content of about 15.4 wt. %, whereas Zeemeeuw has a protein content of about 8.5 wt. %. FIG. 6 shows in duplicate the batter based on an overmixed dough with hyacinth flour and the standard batter, also based on hyacinth flour, but wherein no overmixed dough was made. It is clear that the batters based on an overmixed dough have a completely different particle size distribution (see also FIG. 2), wherein particles with a particle size above 100 μm are substantially absent, and wherein, relative to the standard batter, the volume % of particles with a size in the range of 1-10 μm is increased, i.e. the contribution of the particles in the range of 1-10 μm is increased relative to the other particles, especially relative to volume % of the particles in the range of 10-100 μm.

Such increase is at least 5 vol. %, more preferably at least vol. 10%, even more preferably at least about vol. 20% (assuming the same batter compositions). In the above cases of FIGS. 2 and 6, respectively, the increase in the 1-10 μm range is about 10 vol. % (from about 15 vol. % to about 25 vol. %) and about 25 vol. % (from about 15 vol. % to about 40 vol. %), respectively.

### Example 3

### Viscosity Measurements

The batters as described above were investigated with respect to their viscosity behaviour with a Paar Physica MCR300, which is a commercial stress rheometer. This rheometer allows to run stress and strain controlled experiments. The rheometer in this experiment is used to probe viscosity as a function of shear rate at constant temperature. The following setup is used:
Geometry: CC27 (concentric cylinders)
Bottom plate: TEZ150P-C
Shear rate: 0.01-1000/s→36 data points, interval 10 s 1000-0.01/s→36 data points, interval 10 s
Temperature: 22° C.

The geometry was filled with batter and allowed to rest for 15 min at 22° C. before measurement was started, preferably at least 30 minutes. The viscosity measurements provide are depicted in FIG. 3. Homogenized batter 3 (see example 1) is indicated with dots, standard batter 1 (see example 1) is indicated with triangles and the batter based on overkneaded dough (batter 2; see example 1) is indicated with squares. The upper curve for each batter indicates the curve obtained when increasing the shear rate; the lower curve indicates the curve obtained when again decreasing the shear rate. At shear rates >1 s⁻¹ the apparent viscosities of the overkneaded and homogenized batters are lower than apparent viscosity of standard batter. It is clear that for example when increasing the shear rate, at shear rates larger than about s⁻¹, the apparent viscosity of batters according to the invention is lower. When decreasing shear rates again, for example starting from 1000 s⁻¹ to 1 s⁻¹, the same conclusion can be drawn. From the figure can be concluded that a batter (with 47.5 wt. % water) according to the invention has an apparent viscosity of less than 0.6 Pa·s at shear rates between 10 and 1000 s⁻¹. As will be clear to the person skilled in the art, other criteria can also be derived from the figure.

In case measurements are repeated, i.e. a new increase of shear rates is started after a cycle of increase and decrease, again preferably at least 15 minutes, preferably at least 30 minutes, rest is allowed, before the next measurement cycle is started.

The apparent viscosity data are based on batters comprising 47.5 wt. % water. In case a batter comprises another percentage of water and one desires to compare the batter with above data, the batter may be diluted with water or concentrated to a water content of 47.5 wt. %. Then the apparent viscosity is measured and a batter according to the invention may substantially fulfil above mentioned criteria, whereas batter not according to the invention do not.

It further appears that the batter according to the invention has an apparent viscosity value at shear rates between 10 and 1000 s⁻¹ which is at least 10%, more preferably at least 20%, even more preferably at least 30%, yet even more preferably at least 40%, and even more preferably at least 50% lower than a standard batter with the same composition, prepared according to state of the art methods, and measured under the same conditions. For instance, at 1000 s⁻¹, the standard batter (see example 1, batter 1) has an apparent viscosity value of 0.616 Pa·s, whereas the batters according to the invention have apparent viscosities of 0.351 and 0.191, respectively. At a shear rate of 100 s⁻¹ (with increasing shear rate), these values are 1.29, 0.461 and 0.207, respectively (for the standard batter 1, the homogenized batter 3 and the batter 2 based on an overkneaded dough).

### Example 4

### Lab-Tests on Fried Crusts: Texture Analysis and Sound Recording

Mechanical test are widely used for the determination of textural attributes of (semi) solid foods. For crisp foods the sound emitted during mastication is often described as being an important characteristic of these foods and is therefore often used as indicator of crispness. The method described here is different compared to other methods found in the vast amount of literature on this topic. Most important the test combines the mechanical and acoustical data which gives additional information compared to analyzing sound or mechanical data only. Moreover the test uses a deformation speed of 40 mm.s⁻¹, which is representative of the speed of incisor penetration during human mastication. This test speed is 100-1000× faster than speeds regularly used in literature. To work with these high deformation speeds means that the deformation studied occurs in a relative short time interval. To accurately record signals of short duration analogue output of the texture analyzer was converted by a Bruel and Kjaer A/D converter into a 65 000 pps signal (normally the texture analyzer software works with 500 pps). To mimic the shape of a human incisor a wedge shaped probe with an angle of 30° was used for deformation. During deformation sound is recorded simultaneous with the force signal by a B&K free-field microphone. The same A/D converter as for the force signal is used for digitalizing the signal of the microphone, again at 65 000 pps.

The digital sound and force signals are recorded and stored by PULSE 9.0 (B&K) software. Sound Quality (B&K) is used to convert the PULSE files into excel files. The data are further analyzed by the use of three excel macros (in VBA). To minimize the effect of environmental sound the tests are performed in an acoustic insulated chamber (sound reduction of 50 dB). Moreover the texture analyzer is insulated to minimize sound emission by the equipment.

The Excel-VBA macro determines the amount of work, the maximum force and the number of peaks in the force signals. A similar VBA macro was used for determination of the sound pressure level (dB), sound intensity and the amount of events in the sound signals.

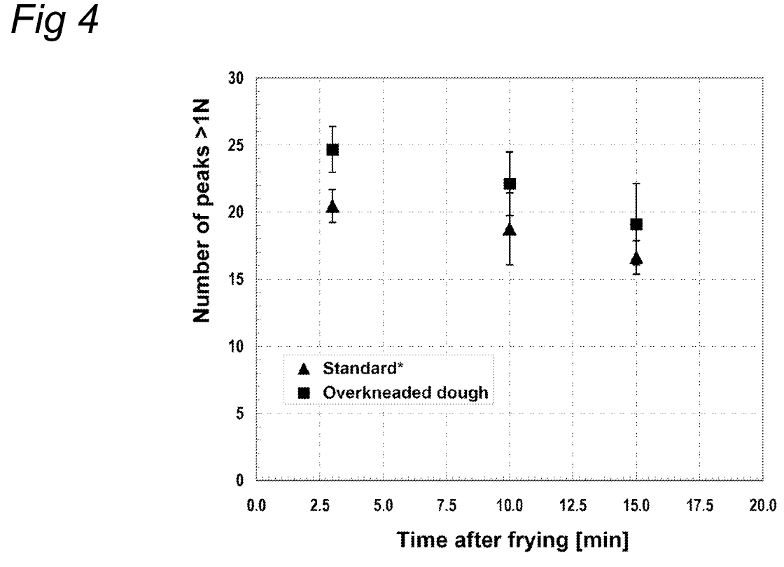

The number of peaks/events in the force vs. time graphs and the sound pressure vs. time curves were determined using an algorithm counting the number of events as a function of event size. Under the same conditions (for instance threshold value for events) crusts based on standard batter 1 and batter 2 based on an overkneaded dough were measured according above mentioned method as function of frying time, see FIG. 4. The number of events appears to be larger for the crust based on the overkneaded dough (batter 2) than for the standard batter 1. The results show that the crust of the batter based on the overkneaded dough gives a different mechanical response during the deformation test compared to the crust of the standard batter. The number of peaks in the force vs. time graph of these crusts is higher. Previous experiments have shown that crispness of the snacks correlates to the amount of peaks in the force vs. time graphs; the more peaks (i.e. events), the crispier the products.

### Example 5

### Lab-Tests on Fried Crusts: Water Content in Crust

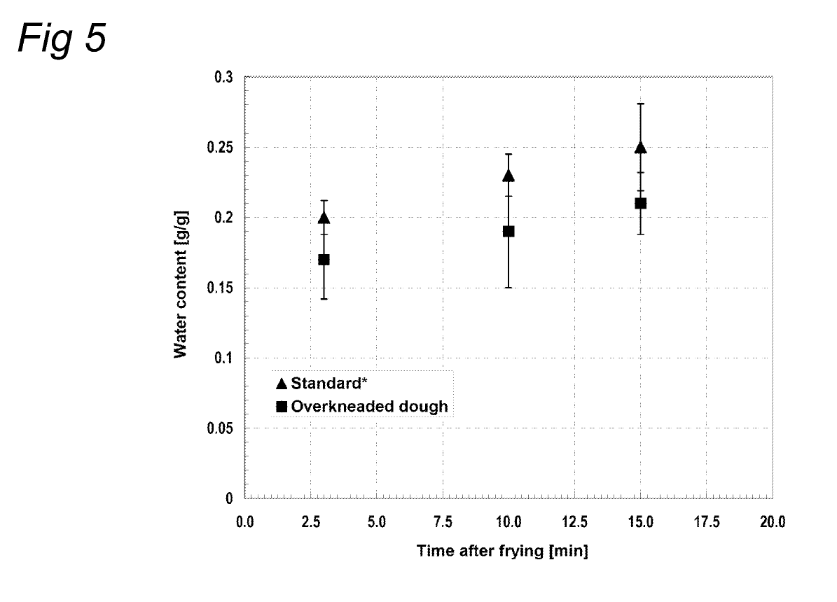

The water content was determined by drying the crusts at 105° C. for 12 hours. Water content was calculated as the mass loss during drying (expressed as grams of mass loss per gram of initial weight). The results are shown in FIG. 5. The crust (after frying) of the batter based on the overkneaded dough has a lower water content, preferably at least 10 wt. %.

These results and the results from example 4 corresponds to a more crispy crust, which was confirmed by a preliminary sensory test. The coatings of the fried or deep-fried food product according to the invention were estimated to be at least 10% more crispy than food products coated with state of the art batters.

### Example 6

### Batter Stability

The batters were stored at 6° C. for 20 hours. It appeared that the state of the art batter was degraded and showed sedimentation, resulting in a more concentrated lower layer and a less concentrated upper layer, whereas the batter according to the invention was still homogeneous. A batter is provided obtainable by the methods for making a batter according to the invention, wherein the glutenin particles do not re-agglomerate and/or show sedimentation within 12 hours after preparation of the batter when stored at 15-25° C.

### Example 7

### Concentration Range of Water in Batter According to the Invention

A batter was made, similar as described above, having the following composition:

| | |
|---|---|
| Wheat flour (Zeemeeuw): | 25; |
| Potato starch: | 25; |
| Salt: | 1; |
| Baking Powder: | 1.5; |
| Water: | 47.5 |

A dough at 0° C. was needed with 49 gram flour, 2 gram salt and 28 ml water (total 79 gram). After overkneading (decrease of torque to about ⅔ of the maximum torque (i.e. a decrease of the torque with about ⅓ from the maximum to ⅔ of the maximum torque)), half of the total amount of dough was removed and frozen. To the rest of the dough, 24.5 gram potato starch, 1.5 gram baking powder and an amount of water was added. The mixture was kneaded or mixed into a homogeneous mixture. The amount of water added increases with time. Each time after adding water, a homogenous mixture was made and the flowability inspected and the torque was measured. At about 40 wt. % water, the mixture starts flowing. At about 42.5 wt. % water the mixture is a real batter flowing like a batter. As will be clear to the person skilled in the art, other compositions may flow like a batter at a lower water content.

### Example 8

### Use of Ethanol

The experiments described above may also be performed by replacing at least part of the water in the starting mixture and/or by replacing at least part of the water that is added after homogenization or overkneading by ethanol.

However, it appears that crispness and crispness retention of the crust of fried snacks can also be improved to a certain extent by simply adding ethanol to the mixture (without overkneading, homogenization or an enzymatic process as described herein).

For instance, a batter can be prepared by mixing first all dry components (wheat flour, starch, salt and additional components) and next mixing/diluting them in a 20 vol. % ethanol-water mixture. The batter can have the composition as described herein. Though the particle size distribution is the same as in prior art batters (see also FIG. 2), also in this way crispness and crispness retention of the crust (i.e. the crust after frying or deep frying) can be obtained.

When using ethanol in the homogenization method, the overkneading method or the enzymatic particle size reduction method as described herein, the crispness and crispness retention effects may even be enhanced.

Hence, with this finding the crispness is improved and the retention of the crispness can be prolonged and using an ethanol-water mixture for the batter preparation in stead of just water may be beneficial. In this way, advantageously the crust properties after frying can be (further) improved.

### Example 9

### Use of Enzymes

Besides by getting a more crispy crust starting from a batter based on overdeveloped dough or by homogenizing a dough (as described above), it is also possible to use proteases in the standard recipe for batter preparation. In this way also a more crispy crust can be obtained after deep-frying.

The effect of enzyme treatment was tested for batters prepared from a commercial flour, Zeemeeuw from Meneba, the Netherlands. Two proteases were used, B500 (1800 ppm) and PPU 95000 (200 ppm) supplied by DSM. B500 en PPU are mixtures of enzymes and both mainly comprise endoproteases. B500 is produced by Bacillus amylolique faciens en PPU 95000 by Aspergillus oryzae. The first one has a strong gluten degradation activity and the second one only a mild degradation effect without danger of complete gluten hydrolysis. The proteases were added for mixing in the Hobart. The enzymes and other batter components and water were mixed for 3 minutes and allowed to rest for 1 hour at room temperature (around 20° C.).

Addition of 1800 ppm B500 gave a crust with an increased crispiness even when compared to a crust made from a Zeemeeuw flour batter based on the overmixing procedure with the Farinograph. The B500 enzyme addition gave the best crispiness in the range of tested methods and ingredients. Both the enzymes showed more colouring of the crust after (deep-)frying. Based on the above results batter was made starting from a commercial battermix (Unifine 1) to which during batter preparation enzyme (1800 ppm B500) was added. An improvement in crispiness of the crust was found, indicating that the use of enzyme add additional crispiness to commercial batters.

### Example 10

### Effect of Enzymes or Overkneading on Sensorial Assessment

Preparation of standard batter (batter 1): The method for preparing a standard batter is the following: mix a batter of 150 grams of wheat flour, 150 grams of potato starch, 6 grams salt, 1.2 grams Sodium bicarbonate, 1.5 grams of Sodium Acid Pyro Phosphate (SAPP 28) and 285 ml water of room temperature in a bowl of a Hobart mixer at stage 1 for 3 minutes. Control that the batter is homogeneous. Let the batter rest for one hour before use.

Basic Batter Recipe:

| | | |
|---|---|---|
| Flour: 150.0; | Potato starch: 150.0; | NaCl: 6.0; |
| Sodium bicarbonate: 1.2; | SAPP 28: 1.5; | water: 285.0 |

The properties of the Hobart mixer are: Brand: Hobart; Model: N-50.

Batter 2: Preparation of batter by Farinograph overmixing (i.e. overkneading)

The effective method for preparing a batter by extreme overmixing is the following: mix dough of 250 grams of wheat flour, 5 grams salt and 150 ml cold water (0°-5° C.) in a 300 grams bowl of a Brabender Plastograph at 100 rpm. As soon as the flour is hydrated, speed up the mixer from 100 to 150 rpm. Cool the bowl by a water bath to 0° C. The curve of the torque soon shows a rather sharp maximum. Continue mixing until the torque has at least become 30% less than the maximum torque (has decreased at least by 30% from its maximum value). Stop mixing and remove half of the weight of the dough. Add 125 grams of potato starch, 2.5 grams salt, 6.5 grams baking powder and 65 ml of cold water (0-5° C.). Start again the mixer with 150 rpm for 10 minutes. Slowly dilute the dough with 100 ml cold water (0-5° C.) at a speed of 150 rpm. The batter is ready to use.

Batter 3: Preparation of commercial batter (Bali rich recipe) by Farinograph mixing (overkneading): The effective method for preparing a batter by extreme overmixing is the following: mix dough of 222.4 grams of wheat flour, 5 grams salt and 150 ml cold water (0°-5° C.) in a 300 grams bowl of a Brabender Plastograph at 100 rpm. As soon as the flour is hydrated, speed up the mixer from 100 to 150 rpm. Cool the bowl by a water bath to 0° C. The curve of the torque soon shows a rather sharp maximum. Continue mixing until the torque has at least become 30% less than the maximum torque (has decreased at least by 30% from its maximum value). Stop mixing and remove half of the weight of the dough. Add 110 grams of maize starch, 55.9 gram of rice starch, 21.9 gram maltodextrin and 3.5 grams salt, 6.5 grams baking powder and 155 ml of cold water (0-5° C.). Start again the mixer with 150 rpm for 10 minutes. Slowly dilute the dough with 170 ml cold water (0-5° C.) at a speed of 150 rpm. The batter is ready to use.

Frying and prefrying: The battered products were fried at 170° C. during 120 seconds in oil. Some products were also pre-fried at 170° C. during 60 second, cooled at room temperature (20° C.) for 30 minutes. After packing these products were blast frozen at −30 for 30 minutes and then stored at −24° for circa 1 week. After this week frozen storage the samples were fried directly out of the freezer for 120 seconds.

Sensorial assessment: 10 minutes after frying the sensorial evaluation is performed. The products were assessed on crispiness. With plusses and minuses, additional to this score, a description of the crispiness is given as well as remarks on colour, bow off and adhesion. For the retention of crispiness some sensorial assessments were performed 5, 10 and 15 minutes after frying.

Effect of frozen storage: Products were also pre-fried and stored frozen for circa 1 week. After this week frozen storage the samples were fried directly out of the freezer for 120 seconds. After frozen storage all the samples tested were assessed as crispy, with variations in type of crispiness. The crispiness varied from hard glassy to brittle soft. The enzyme treated sample showed more colour after frozen storage.

Retention of crispiness: For the Hobart mixed Zeemeeuw, Hobart mixed Zeemeeuw with B500, Hobart mixed Unifine 1 (see Example 9) and the Farinograph mixed Zeemeeuw sensorial assessment were performed 5, 10 and 15 minutes after frying for indicating the retention.

The table below shows the decay in crispiness for all the tested recipes and mixing procedures. The use of enzyme results in the most brittle crispy product after 5 minutes and is still crispy after 15 minutes.

Sensorial assessment for retention time (5-15 min) for mixed Zeemeeuw, Hobart mixed Zeemeeuw with B500, Hobart mixed unifine 1 and the Farinograph mixed Zeemeeuw:

| | | | | | | |
|---|---|---|---|---|---|---|
| Assessment | 5 | | 10 | | 15 | |
| Farinograph | +++ | hard crispy | 0/+ | tough | + | little tough, |
| Zeemeeuw | | brittle | | | | hard |
| Hobart Zeemeeuw | 0 | tough soft | 0 | tough | 0 | tough, soft |
| (reference) | | (not crispy) | | | | |
| Hobart Zeemeeuw | ++++ | brittle | ++++ | very brittle | ++ | brittle (less |
| B500 | | | | | | hard) |
| Unifine | ++½ | glassy crispy | ++ | glassy crispy, little | + | hard brittle |
| | | | | tough under layer | | with soft areas |

From these data can be concluded that a batter based on an overkneaded dough or a batter wherein the particle size of the glutenin particles is reduced by enzymes provides a crust after frying that is crispier and has a better crispiness retention. Even an intermediate freezing is not detrimental.

### Example 11

### Examples of Suitable Flours

Below, a non-limiting summary is given of flours suitable for use in the invention. These flours are for instance provided by Meneba:

Flour Specification

| | Ash (%) | Protein (%) | Hagberg (sec)** |
|---|---|---|---|
| Zeemeeuw | 0.4 | 8.5 | 275 |
| Zwaluw | 0.67 | 10.5 | 220 |
| Edelweiss | 0.58 | 12.5 | 280 |
| Hyacint | 0.6 | 15.4 | 280 |
| Bali* | 0.75 | 10.5 | |
| Borneo* | 0.65 | 10 | |

*This concerns scalded flour
**The Hagberg number is a measure of starch quality of cereal grains related to sprouting of the wheat kernels. On sprouting alfa-amylase activity increased leading to break-down of part of the starch. The Hagberg number or Hagberg falling number of the flour herein is preferably larger than about 120 sec. The Hagberg falling test is a test known to the person skilled in the art.

### Example 12

### Batter

A conventional batter was made. Alcohol soluble proteins from a cereal grain (examples of such cereal grains are barley, corn, millet, oats, quinoa, rice, rye, sorghum, triticale, wheat and wild rice) was added to the batter. The fried coating based on the batter appeared to be crispy and tended to be crispier than without such addition.

It should be noted that the above-mentioned embodiments and examples illustrate rather than limit the invention, and that those skilled in the art will be able to design many alternative embodiments without departing from the scope of the appended claims. Use of the verb “to comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. A method of making a food product, comprising coating a non-fried or non-deep-fried food product with a batter that comprises flour, water and optionally starch, and further comprises
(i) glutenin particles, the volume surface averaged particle size of which is smaller than 10 μm, and
(ii) at least 40 weight (wt.) % water.

2. The method according to claim 1, wherein the batter
(a) has a particle size distribution with the following property: at least 95 vol. % of the particles have a particle size of 100 μm or less, and
(b) comprises 40-60 wt. % water.

3. The method according to claim 1, wherein the food product comprises a filling that originates from a source selected from the group consisting of meat, poultry, fish, vegetable, fruit, cereal and nut.

4. The method according to claim 1, wherein the product is coated coating is performed by
(a) submerging the non-fried or non-deep-fried product in the batter,
(b) spraying the batter on the non-fried or non-deep-fried product, or
(c) coating the non-fried or non-deep-fried product with the batter.

5. The method according to claim 1, further comprising frying the coated, non-fried product or deep-frying the coated, non-deep-fried product.

6. The method according to claim 1, further comprising frying the coated, non-fried product or deep-frying the coated, non-deep-fried product and freezing the coated, fried or deep-fried food product.

7. The method according to claim 6, further comprising, after said freezing frying or deep-frying the frozen product either from a frozen state or after at least partial thawing product.

8. The method according to claim 1, wherein the flour comprises wheat flour.

9. The method according to claim 1, wherein the batter comprises at least 50 wt. % water.

10. The method according to claim 1, wherein the batter further comprises ethanol.

11. The method according to claim 1 wherein the batter further comprises proteolytic enzymes.

12. The method according to claim 11, wherein. the enzymes are present in an amount of about 10-25000 CDU proteolytic activity per gram flour.

13. The method according to claim 11 wherein the proteolytic enzymes comprise wheat bug protease.

14. A batter for coating a food product, the batter comprising flour, water and optionally starch, and further comprises
(a) glutenin particles with the following properties:
(i) a volume surface averaged particle size which is less than 10 μm, and
(ii) a particle size distribution wherein at least 95 vol. % of the particles have a particle size of 100 μm or less; and
(b) 40-60 wt. % water.

15. The batter according to claim 14, that further comprises proteolytic enzymes.

16. The batter according to claim 15 wherein the enzymes are present in an amount of about 10-25000 CDU proteolytic activity per gram flour.

17. The batter according to claim 14, wherein the glutenin particles do not re-agglomerate within 12 hours after preparation of the batter.

18. The batter according to claim 14, wherein the glutenin particles have a volume surface averaged diameter between 0.1 and 10 μm.

19. A coated food product produced by the method according to claim 1.

20. A method for making a fried or deep-fried food product with a reduced fat content crust, comprising coating a non-fried or non-deep-fried food product with the batter according to claim 14.

21. (canceled)

22. The batter according to claim 15 wherein the proteolytic enzymes comprise wheat bug protease.

23. The batter according to claim 18, wherein the volume surface averaged diameter is between 2 and 5 μm.

24. A method for making a coated food product that has a crust with a reduced fat content after frying or deep-frying the coated food product, which method comprises coating a non-fried or non-deep-fried food product with a batter that comprises wheat bug protease.
